(19) United States
(12) Patent Application Publication
(10) Pub. No.: US 2025/0073658 A1
(43) Pub. Date: Mar. 6, 2025

(54) MIXER

(71) Applicant: WAYNE FROMM, Toronto (CA)

(72) Inventor: WAYNE FROMM, Toronto (CA)

(21) Appl. No.: 18/951,187

(22) Filed: Nov. 18, 2024

Related U.S. Application Data
(63) Continuation-in-part of application No. 18/220,219, filed on Jul. 10, 2023.
Application No. 18/220,219 is a continuation-in-part of application No. 17/969,657, filed on Oct. 19, 2022.

(51) Int. Cl. B01F 33/501; A47J 43/044; A47J 43/07; A47J 43/08; B01F 35/32; B01F 35/50; B01F 101/06

(52) U.S. Cl. CPC B01F 33/50114; A47J 43/044; A47J 43/082; B01F 35/32025; B01F 35/50; A47J 2043/04427; A47J 2043/0738; B01F 2101/06

(57) ABSTRACT

A child-friendly mixing apparatus for mixing various food substances is disclosed. The mixing apparatus includes a container with an opening, a lid that fits into the opening, and a mixing assembly. The lid includes a centrally located hole that has shaped sides, and a conductive ring. The mixing assembly includes a housing, a motor within the housing, a mixing attachment that is rotated by the motor, and two electrical connector pins. The mixing attachment fits through the lid hole and the lower end of the mixing assembly rests against the shaped sides of the lid hole. The electrical connector pins are connected electrically by the conductive ring when the mixing assembly is placed in the lid in an operational position, thus engaging the motor.

### CROSS-REFERENCE TO RELATED APPLICATIONS

The present application is a continuation-in-part of U.S. patent application Ser. No. 18/220,219, entitled “MIXER,” filed Jul. 10, 2023, which is a continuation-in-part of U.S. patent application Ser. No. 17/969,657, entitled “MIXER,” filed Oct. 19, 2022, each of which is incorporated by reference herein in its entirety.

### BACKGROUND

This specification relates generally to food processors and more specifically to mixers safe for use by children. Various types of mixers are known in the art, such as electric powered hand mixers, stand mixers, and others. Some toy mixers are also found in the art. For example, U.S. Pat. No. 3,774,338 discloses a crank-activated toy blender and percolator. The '338 patent, however, does not use electricity, and requires significant manual dexterity to operate.

Frothers, which are devices configured to add air bubbles to a liquid, are also known in the art. Prior art electric frothers are typically hand-held devices that include a motor, an on/off switch, and a frothing element. When the frother is turned on, the motor rotates the frothing element, adding air bubbles to the liquid. An alternative prior art frother (e.g., U.S. Patent Publication No. 2019/0216257 to Lui et al.) incorporates air into the liquid through injection of steam.

However, the mixers and frothers in the art are generally not safe for use by children. Mixer motors can spin at over 15,000 RPM or even faster. At these speeds, the mixing/frothing elements can cause injury if they come into contact with sensitive parts of the user's body (e.g., eyes, mouth, face, etc.) while spinning. The mixing/frothing elements can also get entangled with children's hair, increasing injury risk. Some mixing/frothing elements additionally have sharp edges or other parts, which can further increase the risk of injury. Furthermore, the mixers and frothers in the art are not child- friendly to operate, in that they require manual dexterity (e.g., in holding steady a hand mixer or frother while the motor is running).

There remains a need for a child-friendly mixer that is child-safe, easy for children to use, does not require significant manual dexterity or constant pressure, and is battery-powered to prevent risk of electric shock. It would be beneficial if the mixer is capable of mixing a wide variety of ingredients, including, e.g., liquids (e.g., milk, water, juice, etc.), flavored powders, dairy products (e.g., yogurt, ice cream, whipped topping, etc.), non-dairy milks (e.g., plant-based milks, such as almond or soy milk), non-dairy yogurts, non-dairy frozen products, fruits, sprinkles and other mix-ins, etc., and of frothing various liquids.

### SUMMARY

In accordance with the foregoing objectives and others, exemplary mixers are disclosed herein that are child-friendly and child-safe.

One embodiment is directed to a mixing assembly comprising: a housing configured to interface with a hole in a lid of a container; a motor disposed within the housing; a power source configured to provide power to the motor; a mixing element directly or indirectly attached to the motor, wherein the mixing element is sized to fit through the hole in the lid; and at least one electrical connector pin electrically coupled to the motor; at least one electrical connector pin electrically coupled to the power source; wherein the electrical connector pins are configured so that a conductive element outside the housing can complete a circuit between the motor and the power source by electrically connecting the electrical pins to each other.

Another embodiment is directed towards a mixer kit, comprising: a mixing assembly as recited above; a lid for a container, the lid comprising a hole sized to accommodate insertion of the mixing assembly therein, the hole including an inside surface, the lid comprising a conductive element disposed on the inside surface of the hole, wherein the conductive element is configured to electrically connect the electrical connector pins when the mixing assembly is inserted into the hole.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an embodiment of a mixer in an operational position.

FIG. 2 illustrates an embodiment of a lid for a container.

FIG. 3 illustrates an embodiment of a mixing assembly.

FIG. 4 illustrates an exploded view of a mixing assembly.

FIG. 5 illustrates an embodiment of a container and a lid.

FIG. 6 illustrates an embodiment of a straw adapter.

FIG. 7 illustrates an embodiment of a measuring spoon.

FIGS. 8 and 9 illustrate an embodiment of a combined mixing attachment.

FIG. 10 illustrates an embodiment of a housing.

FIG. 11 illustrates a cutaway view of an assembled container and lid.

FIG. 12 illustrates an embodiment of a mixer in an operational position.

FIG. 13 illustrates an exploded view of a mixing assembly.

FIG. 14 illustrates an embodiment of a portion of a mixing assembly.

FIG. 15 illustrates an embodiment of a storage disc.

FIG. 16 illustrates an embodiment of a container and a lid.

FIG. 17 illustrates an embodiment of a mixer in a position suitable for storage with a storage disc.

### DETAILED DESCRIPTION

Various embodiments are disclosed herein to provide a mixer that uses the force of gravity to help operate the mixer when the parts of the mixer are in an operational position. Unlike conventional mixers, the disclosed mixers reduce the need for application of manual pressure to operate the mixer, while still remaining easy to use and safe for children. The disclosed mixers are also impact and shatter-resistant, and prevent breakage of the mixing attachment when the mixing assembly is removed from the container.

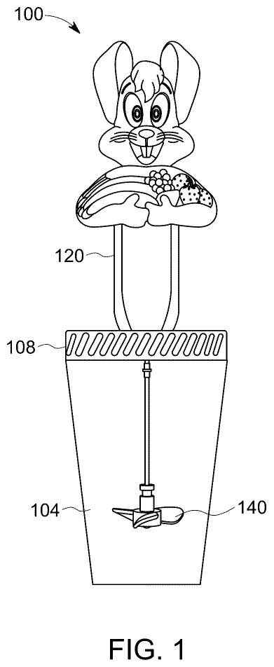

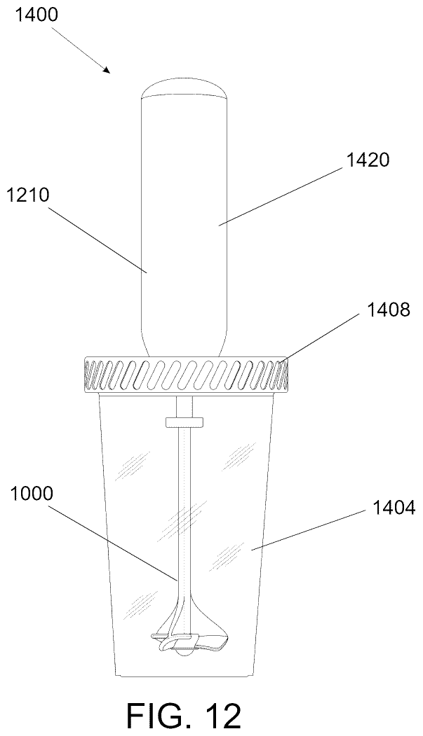

As used herein, bottom and top and lower and upper refer to the normal operating position of the mixer, e.g., as illustrated in FIGS. 1 and 12. In the following disclosure, examples of mixing drinks are primarily used, but the mixer may be used to mix other types of food substances, for example puddings, dairy products (e.g., ice cream and yogurt), non-dairy yogurts, non-dairy frozen products, etc. The mixer may also be used to froth liquids and even mix non-food substances. However, in preferred embodiments all materials are food safe.

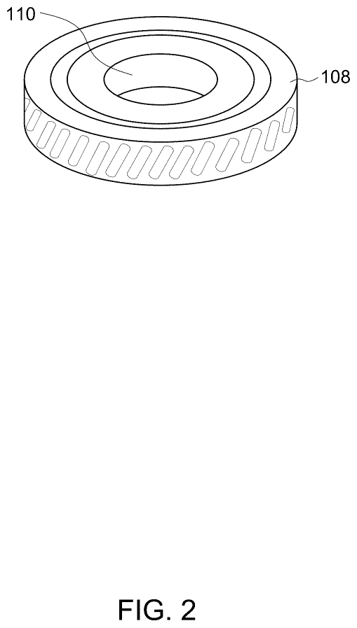

Turning now to FIG. 1, an embodiment of a mixer 100 is shown. The mixer includes a container 104, a lid 108, and a mixing assembly 120. The lid 108 is illustrated in more detail in FIG. 2. Marshalled though the middle of the lid 108 is a hole 110 sized to accommodate various food powders, such as drink mixes, pudding mixes, etc. The hole 110 is also sufficiently large in diameter to enable the pass-through of mixing attachment 140. The hole may have curved and/or sloped sides.

The container 104 and lid 108 may be made of any suitable material, e.g., food-safe plastic, etc. In an embodiment, the material may be impact-and/or shatter-resistant. In an embodiment, the container may be transparent or substantially translucent for easy viewing of the mixing process.

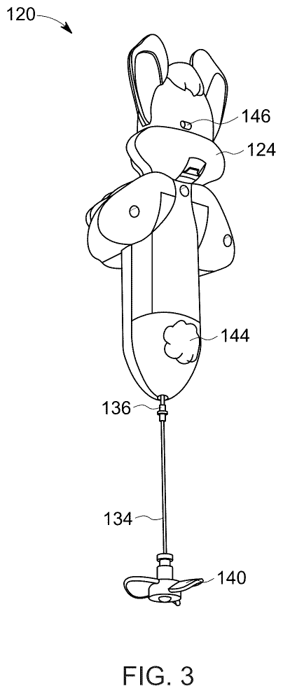

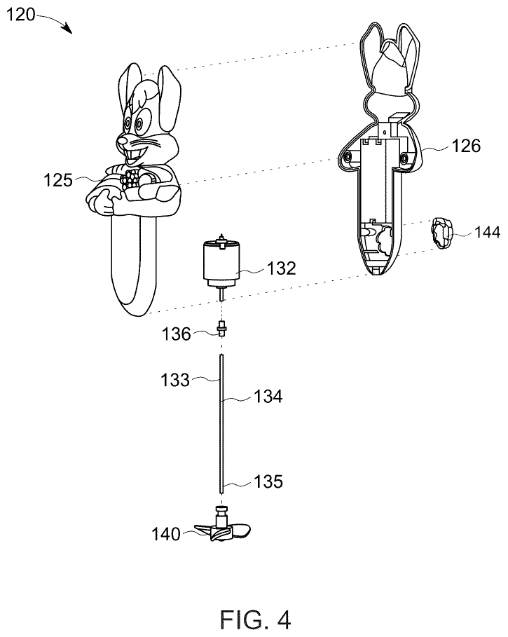

FIGS. 3 and 4 illustrate assembled and exploded views respectively of the mixing assembly, The mixing assembly 120 includes a housing 124, a power source (not shown), a motor 132, a rod 134, a mixing attachment 140, an activation switch 144, and an optional on/off switch 146.

The housing 124 may be separated into two or more pieces (125, 126) for ease of manufacturing and/or assembly. If so, the pieces may be joined using any suitable attachment means, e.g., screws, glue, etc. The housing may be made of any suitable material, e.g., plastic. In an embodiment, the housing may be made of an impact-and/or shatter-resistant material.

In an embodiment, the housing 124 may be formed in a kid-friendly shape, e.g., an animal (e.g., a rabbit, reptile, dinosaur, etc.), an insect (e.g., butterfly, ladybug, etc.), an anthropomorphic animal, a mythological creature (e.g., a unicorn, etc.), a cartoon or comic character, a fantasy character (e.g., a wizard), a sports player, a non-sports celebrity, an object related to sports (e.g., football, etc.), various types of foods (e.g., vegetables, fruits, etc.), etc. Any shape that may be of interest to children is contemplated to be within the scope of this invention.

The power source drives the motor 132, and may comprise a battery (e.g., alkaline), rechargeable battery (e.g., lithium ion, lithium ion phosphate, etc.), or other portable power source. The battery is preferably located in the lower section 127 of the housing 124 to lower the center of gravity of the mixing assembly, which helps balance the mixing assembly during operation.

The rod 134 comprises a first end 133 and a second end 135. The first end 133 is configured to attach to the motor, directly or indirectly (e.g., using an adapter 136). The rod may be made of any suitable material, e.g., metal, plastic, etc., and is sized to place the mixing attachment 140 at the desired position in the container 104. In a particular embodiment, the rod may be a plastic-coated metal (e.g., steel) rod.

In an embodiment, the desired position of the mixing attachment may be based on the amount of cyclonic action the mixing attachment induces during operation between the bottom of the mixing attachment and the bottom of the container, e.g., sufficient cyclonic action to mix liquids, puddings, dairy products (e.g., ice cream and yogurt), non-dairy yogurts, non-dairy frozen products, etc. In a particular embodiment, the position of the mixing attachment may be approximately 15 mm to approximately 25 mm above the bottom of the container (measured between the bottom of the container and the bottom of the mixing attachment). In a more particular embodiment, the position of the mixing attachment may be approximately 20 mm above the bottom of the container.

The mixing attachment 140 is attached to the second end 135 of the rod 134, and may comprise a frother, a beater, an agitator, a paddle mixer, or any other type of attachment that can be used for mixing. The mixing attachment may be made of any suitable material, e.g., metal, plastic, rubber, etc. The mixing attachment may be removable from the rod to enable switching of attachments for various mixing tasks. Generally, the mixing attachment is sized to fit though the lid hole 110. In an embodiment, the mixing attachment may be sized to reach the inside walls of the container when the mixing assembly is in an operational position.

In an embodiment, the rod 134 and mixing attachment 140 are removable from the mixing assembly for convenient cleaning and replacement.

In an embodiment, the rod 134 and mixing attachment 140 are combined into a single element. In another embodiment, the rod 134, mixing attachment 140, and adaptor 136 are combined into a single element. In any of these embodiment, the single combined element may comprise any suitable material, e.g., metal, plastic, plastic-coated metal, rubber or silicone coated metal, etc.

The activation switch 144 is configured to turn the motor 132 on and off. In an embodiment, the activation switch may be any type of switch that can be activated through the application of pressure, e.g., a pushbutton switch, a pressure switch, a friction switch, etc. When sufficient pressure is applied to the switch 144, the motor 132 will be activated. The amount of pressure required to actuate the switch 144 may be configured to be substantially similar to or slightly greater than the amount of pressure applied to the switch 144 when the mixing assembly is in an operational position, thus allowing the motor 132 to be turned on by inserting the mixing attachment of the mixing assembly through the lid hole 110 and placing the lower end 127 of the housing against the sides of the lid hole and applying a slight amount of pressure, e.g., the amount of pressure a child could easily apply. In an embodiment, no additional pressure is necessary-the gravitational force alone is enough to turn on the motor. The switch 144 may be positioned anywhere on the housing 124 that interfaces with the lid 108 of the container 104 when the mixing assembly is in an operational position, such that the lid applies pressure to the switch 144.

In an embodiment, the switch 144 is configured to be water resistant. For example, it may be protected by a water-resistant membrane.

Alternatively, the activation switch 144 may be a light sensitive switch that activates when the switch is covered, or a magnetic switch that is engaged when in proximity to a magnetic field, such as may be produced by a magnet (or other source of a magnetic field) disposed within the sides of the lid hole.

The on/off switch 146 is configured to turn the motor 132 on and off, and may comprise any type of switch, e.g., a pushbutton switch (preferably located in the upper end of the housing 124), a recessed pushbutton switch, a sliding switch, etc. In an embodiment, the on/off switch may be an internal rotational switch, which is activated by rotation of a portion of the housing. In such an embodiment, the housing may comprise additional sections for ease of assembly.

The on/off switch 146 (if present) and the pressure or friction switch 144 control the operation of the motor in a conventional manner. In an embodiment, the motor will only activate if both switches are actuated. This enables a user to prevent accidental activation of the motor, e.g., when the mixing assembly is placed in a kitchen drawer for storage. For example, when in storage, the on/off switch may be set to the ‘off’ position, so if the pressure switch 144 is pressed, the motor will not activate. The on/off switch can be set to ‘on’ when the mixer is being used.

If the on/off switch is not present, the pressure switch 144 may be configured to have a mechanical locking mechanism. In on such embodiment, the pressure switch 144 is round, and can be rotated to mechanically lock the switch, e.g., to prevent it from being pressed and thus activating the motor 132. In this embodiment, the pressure switch can be set to the locked position prior to storage.

The lower end of the housing 127 has shaped sides that interface with the sides of lid hole 110, but may also allow for some pivoting movement, e.g., to allow the mixing element to be pivoted to allow the mixing attachment to reach the sides of the container.

The mixer of the disclosed embodiments may be used with a variety of items, such as off the shelf flavored drinks, e.g., powdered flavored milk mixes, mixed with milk, water or another liquid; pudding mixes mixed with liquid; fruit juices; etc. With the appropriate mixing attachment, e.g., a frother, the disclosed mixer may also be used to add air bubbles to a liquid such as milk.

In operation, a user puts the lid 108 on the container 104 and pours items to be mixed (e.g., drink powders, pudding mixes, liquids, whipped topping, sprinkles, etc.) through the lid hole 110. The user then inserts the mixing attachment of the mixing assembly through the lid hole 110 and rests the lower end of the mixing assembly housing 124 on the lid hole sides, which as described herein are shaped in a manner to hold the lower end of the housing. When the mixing attachment is in the operational position and a small amount of downward pressure is applied, the pressure switch 144 is actuated, causing rotation of the mixing attachment and thereby mixing the contents of the container. The shape of the lid hole sides 110, and the corresponding shape of the lower end of the housing 124, may enable the mixing assembly to be pivoted and/or rotated to aid in the mixing process. The disclosed mixer is easy for a child to use and achieve satisfying results, and will encourage independence.

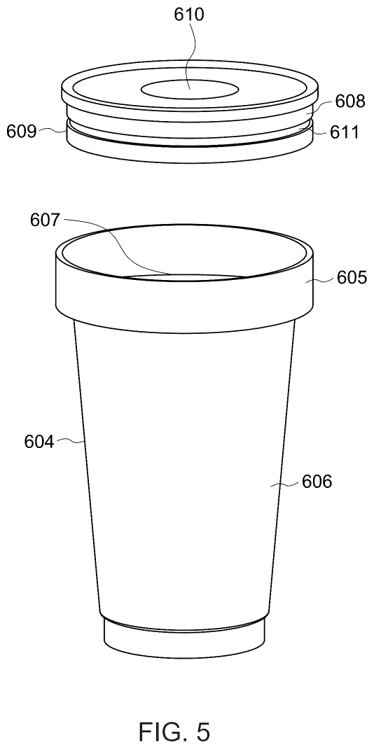

An alternative embodiment of the container is illustrated in FIG. 5, with the container having sloping sides. The container 604 comprises an upper portion 605 and a lower portion 606. The lower portion 606 has sloping sides, with the bottom having a smaller diameter that the top. The sides of the upper portion 605 are substantially straight. Also, the upper portion 605 of the container protrudes outward from the lower portion 606, on both the inside and the outside, creating a ledge 607 on which the lid 608 rests.

The lid 608 is roughly disc-shaped, and includes an outer edge 609 and a hole 610. The lid 608 is sized to enable the outer edge of the lid to securely fit to the top of the container 604, creating a friction seal. The fit of the lid to the container is secure enough to prevent the escape of food particles and/or liquids during normal use of the mixer.

In an embodiment, the lid outer edge 609 includes a groove 613 around its circumference. The groove is sized to accommodate a rubber seal or gasket (e.g, a O-ring, etc.) to aid in providing a secure fit between the lid and the container.

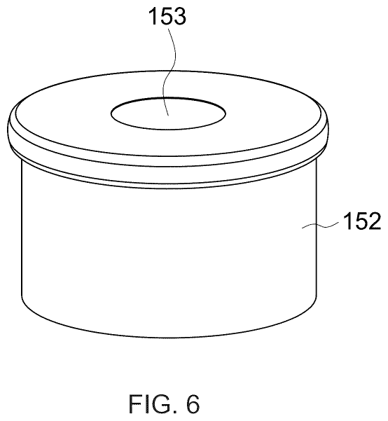

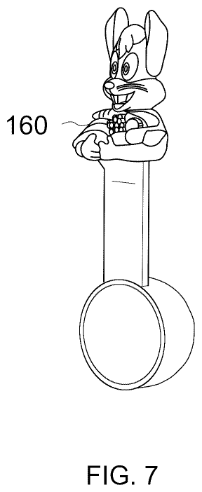

In an embodiment, the mixer may be provided to a user as part of a mixer kit. An example mixer kit includes the mixing assembly 120, the container 104, the lid 108, a straw adapter 152 as illustrated in FIG. 6, and a measuring spoon 160 as illustrated in FIG. 7. The measuring spoon 160 is sized to fit into the lid hole 110, and may be used to measure powders or liquids in appropriate quantities for mixing. The mixer kit may also include molds that can be used to make frozen treats.

The straw adapter is configured to fit in the lid hole 110, and has a centrally-located hole 153 that is sized to accommodate a straw. After the drink is sufficiently mixed, the user can remove the mixing assembly 120 from the lid and insert the straw adapter 152 into the lid hole 110. A straw can then be inserted into the straw hole 153 to ingest the mixed beverage. Alternatively the mixed liquid can be poured into separate containers and refrigerated to form a pudding or placed in a freezer to make frozen treats.

While specific embodiments of a mixer have been disclosed herein, one of ordinary skill in the art will recognize that variations on the disclosed embodiments may be used for the same purpose. For example, the power source may also comprise an A/C adapter. Other variations have been discussed above.

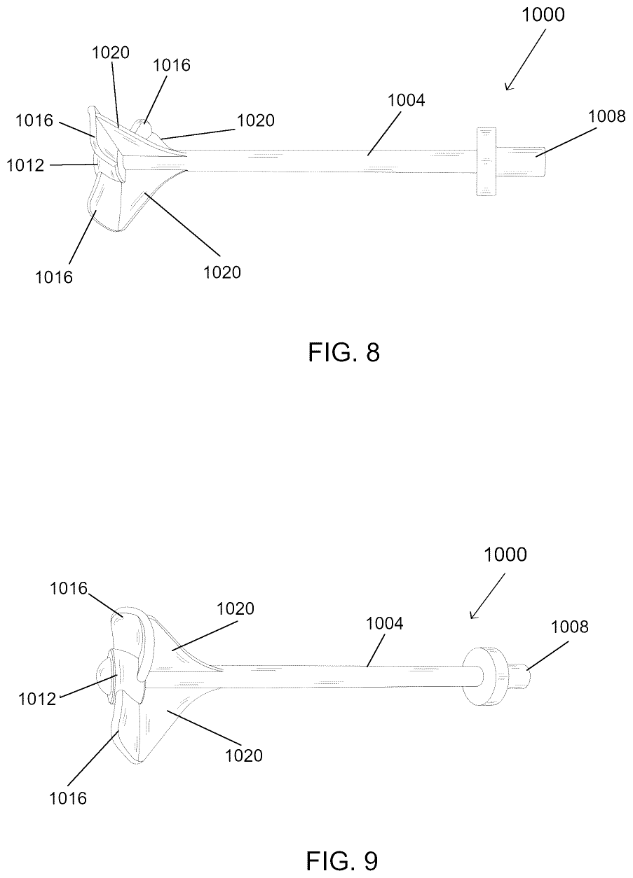

An alternative embodiment of a mixing attachment 1000 is illustrated in FIGS. 8 and 9. In this embodiment, the mixing attachment 1000 comprises a rod portion 1004, an adaptor portion 1008, a terminal portion 1012, one or more blades 1016 and one or more fins 1020. The adaptor portion is configured to interface with the motor 132 as described elsewhere herein. The rod portion is sized to place the terminal portion 1012, including the blades 1016 and the fins 1020, at the desired position within the container 104. The terminal portion has a cylindrical shape with a larger radius than that of the rod portion, and is the base for the attachment of the blades.

In an embodiment, the desired position of the mixing attachment may be based on the amount of cyclonic action the mixing attachment induces during operation between the bottom of the mixing attachment and the bottom of the container, e.g., sufficient cyclonic action to mix liquids, puddings, dairy products (e.g., ice cream and yogurt), non-dairy yogurts, non-dairy frozen products, etc. In a particular embodiment, the position of the mixing attachment may be approximately 15 mm to approximately 25 mm above the bottom of the container (measured between the bottom of the container and the bottom of the mixing attachment). In a more particular embodiment, the position of the mixing attachment may be approximately 20 mm above the bottom of the container.

Each blade 1016 extends out from the terminal portion 1012, and may be curved. The blades are configured to be safe when coming in contact with human skin (e.g., a child's skin), even when being rotated by the motor 132. For example, the blades may be curved in such a manner as to limit irritation when in contact with the user's skin. The edges of the blades may also be shaped to limit irritation, e.g., there may be no sharp corners.

In FIGS. 8 and 9, the blades are spaced equidistant around the terminal portion 1012. However, alternative blade arrangements are contemplated to be within the scope of the present disclosure.

Each blade has an associated fin. Each fin is roughly triangular, with the fin projecting from the top surface of the blade upwards along the rod portion 1008. In an embodiment, each fin is relatively narrow in width, and the outside edge of each fin is curved slightly inward.

The fins serve to prevent the blades from catching on the sides of the opening 110 and possibly breaking when the mixing assembly is removed from the container. Other arrangements of blades and fins for the mixing attachment may be used to provide the same functionality. For example, the fins may have a different curvature or radius on their outside edge. The fins may extend upwards along the rod portion a different length, or have a different width. All particular arrangements of blades and fins that enable easy removal of the mixing attachment while preventing breaking of the mixing attachment are contemplated to be with the scope of this disclosure.

Alternative embodiments of the mixing attachment that limit or prevent breakage of the mixing attachment are also considered to be within the scope of this disclosure, e.g., mixing attachments with flexible elements, mixing attachments made with resilient materials, etc.

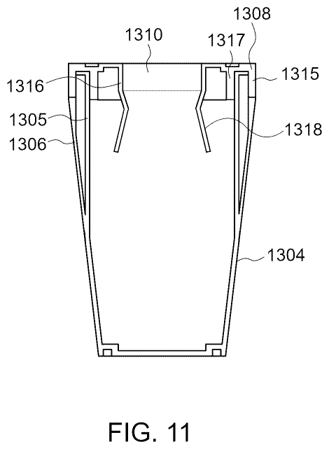

FIG. 11 shows an embodiment of a container 1304 and lid 1308 that serves to limit or prevent breakage of the mixing attachment when it is removed from the container after use. The container includes inner wall 1305 and outer wall 1306.

The lid includes a hole 1310, an outer wall 1315, an intermediate wall 1317, and an inner wall 1316. The inner wall 1316 includes a flared portion 1318. The flared portion has a radius that increases towards the bottom of the inner wall 1316. The wider radius at the bottom of the inner wall enables the user to remove the mixing attachment without breaking the blades or other elements of the mixing attachment, as there is a larger opening for the mixing attachment to enter. In an embodiment, the flared portion may extend all the way to the inner wall 1305 of the container to make it even easier for the user to remove the mixing attachment without risk of breaking.

In some embodiments a combination of the above breakage-prevention elements may be used. For example, mixing attachment fins may be combined with the flared inner wall of the lid to further limit the risk of breakage. All such combinations that serve to limit the risk of breakage of the mixing attachment are contemplated to be within the scope of the claimed invention.

The fins also provide additional agitation to the liquids during the mixing process. The exact shape and size of the blades and fins may also be configured to provide desired mixing characteristics.

The adapter portion, rod portion, terminal portion, blades, and fins may be made of any suitable material, e.g., metal, plastic, rubber, etc. Additionally, the adaptor portion, rod portion, terminal portion, blades, and fins may be made from different materials, e.g., the blades may be made of plastic and the fins made of rubber, though for ease of manufacturing, the elements will generally be made of the same material. In an embodiment, the elements may be separable from each other.

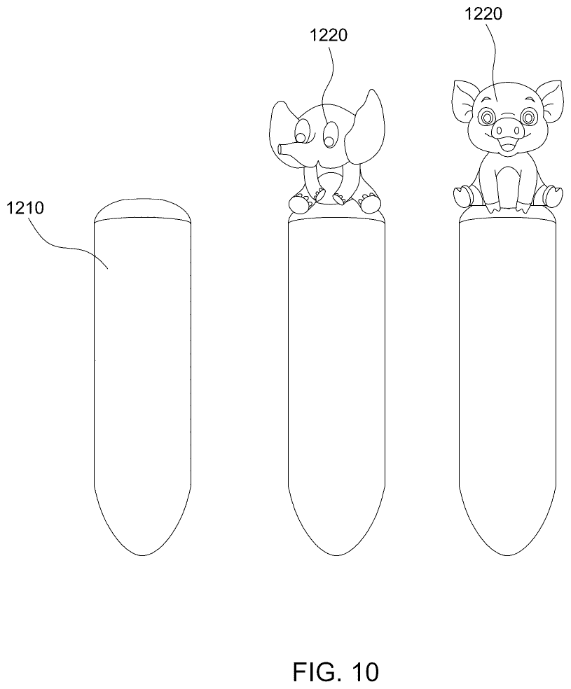

FIG. 10 illustrates an additional embodiment of a housing. In the embodiment shown in FIG. 10, the housing 1210 may be primarily cylindrical in shape with a substantially flat top surface that enables the mixer assembly to stand upside down when not in use. This makes it convenient to dry the mixing attachment after use.

In this embodiment, the top surface of the housing may include one or more connectors to allow the attachment of a collectible figurine (or other object) 1220. The figurine (or other object) includes a matching connector on its underside. The figurine (or other object) allows customization of the mixer, e.g., in families where more than one mixer may be owned.

The connector may comprise any type of connector, e.g., a reusable sticky substance (e.g., polyurethane gel), a magnet in combination with a ferromagnetic metal, male and female fittings, clips, etc.

FIG. 12 illustrates an additional embodiment of a mixer 1400. The mixer 1400 includes a container 1404, a lid 1408, and a mixing assembly 1420, which comprises the mixing attachment 1000 and the housing 1210 described above. The container 1404 is roughly cylindrical in shape, with the top of the container having a larger diameter than the bottom. The bottom of the container is closed and shaped to enable the container to rest on a substantially flat surface. The lid 1408 is substantially as described elsewhere in this application.

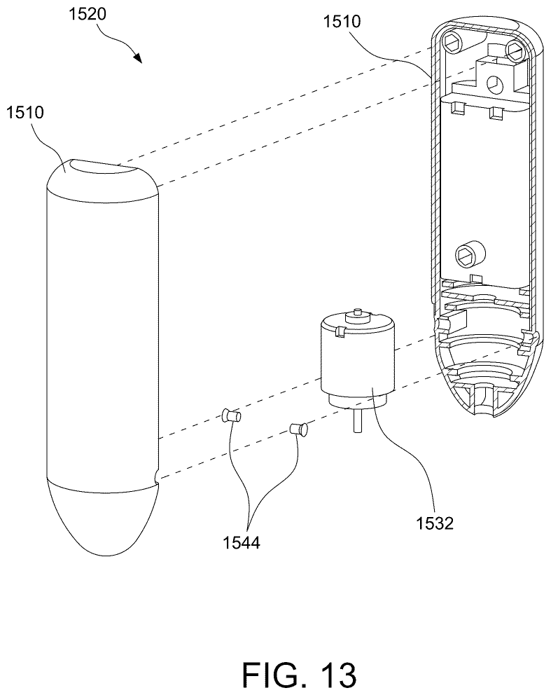

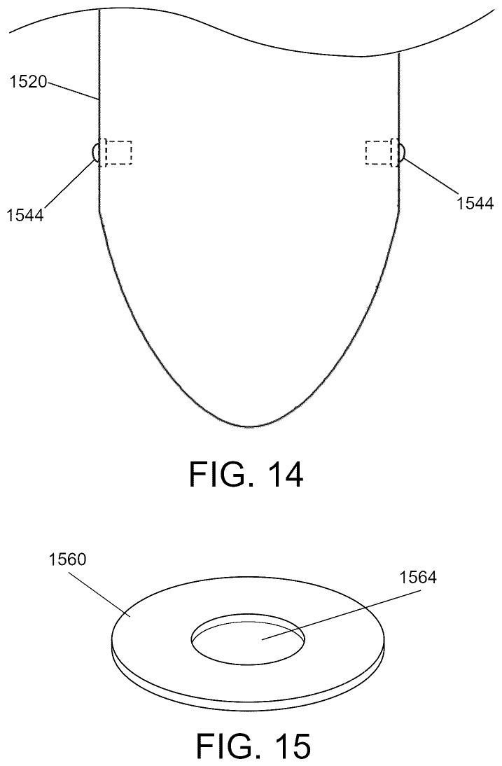

FIGS. 13 and 14 illustrate an additional embodiment of a mixing assembly 1520, with two halves of a housing 1510 and a motor 1532, substantially as described above. Instead of activation switch 144, the mixing assembly 1520 includes two electrical connector pins, or “pogo” pins, 1544 on either side of the housing. In an embodiment, the pins 1544 may be spring-loaded. FIG. 13 is an exploded view of the mixing assembly, with some internal elements and the mixing attachment omitted for clarity. FIG. 14 illustrates the bottom portion of the mixing assembly (without mixing attachment) and, as shown, the pins protrude through holes in the housing, and extend above the surface of the housing as shown.

The pins may be made of any conductive material appropriate for this application, e.g., steel, stainless steel, other food-safe and conductive metals, etc. One pin is electrically connected to the battery and the other is electrically connected to the motor, such that when the pins are electrically connected to each other, a circuit is completed, and the battery powers the motor. In an embodiment, one or more additional switches may be included in the circuit, such that when the pins are electrically connected, the state of the additional switch(es) determines whether the motor is activated. For example, a master on/off switch may be included, and the circuit is configured so that the motor will not be activated unless the master switch is set to ‘on’ and the pins are electrically connected. A tilt switch, configured to shut off the motor if the mixing assembly deviates from a substantially vertical orientation, may also be included. The tilt switch may comprise a sensor for detecting the mixing assembly's orientation, such as an inclinometer, an accelerometer, a tilt sensor, etc.

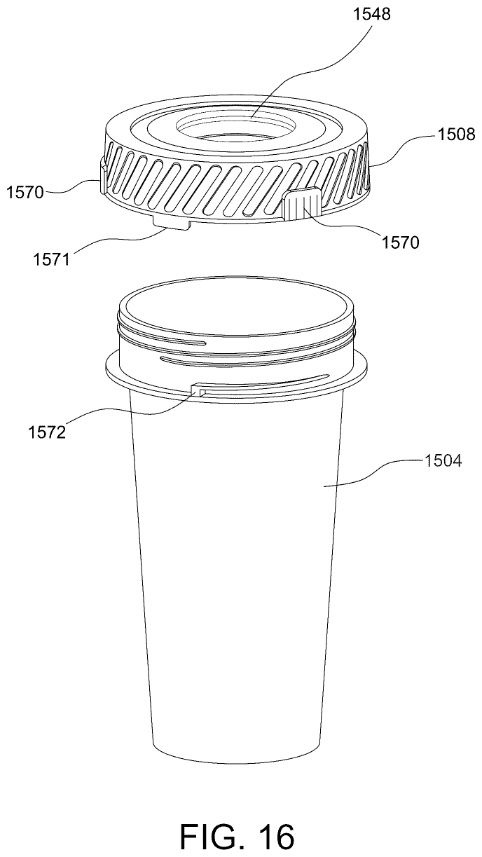

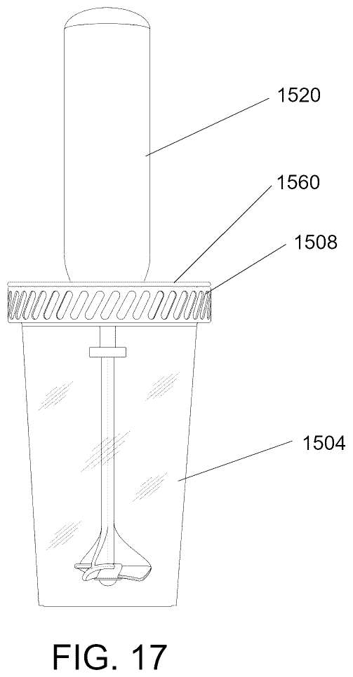

FIG. 16 illustrates a lid 1508 and a container 1504. The lid includes a conductive element 1548 that makes contact with the pins 1544 when the mixing assembly is inserted into the lid. This completes the circuit between the battery and the motor and causes the motor to activate.

In a preferred embodiment, as illustrated in FIG. 16, the conductive element is a metal ring that is attached to the inside surface of the hole. The conductive element can be other shapes, e.g., a half-circle, etc., so long as it is able to electrically connect the pins 1544 when the mixing assembly is inserted into the lid.

In an embodiment, the pins 1544 are spaced equally around the mixing assembly, e.g., two pins may be placed, one on each side. Alternative arrangements will be readily apparent to one of ordinary skill in the art. The pins may be arranged so that the circuit cannot be completed using a flat conductive object, such as a penny or a metal utensil. This increases the safety of the mixer, as it is difficult to activate the motor unless the mixing assembly 1520 is inserted into the lid 1508.

In a preferred embodiment, the lid 1508 is child-safe, e.g., requires multiple motions to remove from the container 1504. Examples of child-safe lids include squeeze and turn, push and turn, snap-lock, etc. As illustrated, the lid 1508 includes a squeeze and turn child safety feature. The lid includes one or more squeeze panels 1570 and a tab 1571, and the container includes a tab 1572. When the lid is fastened to the container 1504, the lid tab 1571 prevents the lid from being turned and removed, because the container tab 1572 blocks the lid tab. To remove the lid, pressure can be applied to the squeeze panels, thereby raising lid tab 1571, providing enough clearance for the lid tab to bypass the container tab 1572. To operate the mixer, a parent or other caregiver can first attach the lid to the container, so the mixing attachment will be unable to spin until the mixing assembly 1520 is inserted into the lid and the mixing attachment is safely inside the container.

These features improve the safety of the mixer, preventing entanglement of hair, injury to eyes, lips, mouth, and other safety risks that are inherent with a fast-spinning—15,000 RPM or more—mixing attachment. The disclosed mixer meets the safety standard described in ASTM (American Society for Testing and Materials) F963-23.

An optional storage disc allows for the mixing assembly 1520 to be stored while inserted into the lid 1508 without activating the motor. As shown in FIG. 15, the storage disc 1560 is a substantially flat, circular disc with a hole 1564 in its center. In an embodiment, the storage disc is approximately the same diameter as the lid 1508. The storage disc is thick enough to prevent the electrical connector 1544 pins from touching the conductive element 1548 when the mixing assembly is inserted through the hole 1564 in the storage disc and into the lid. FIG. 17 shows the mixing assembly 1520, storage disc 1560, lid 1508, and container 1504 assembled for storage.

In an embodiment, one or more additional sensory elements, e.g., lights, LEDs, a speaker that can play sounds and/or music, etc., may be incorporated into the mixing assembly. The mixing assembly may be configured to activate these elements while the motor is activated, or at other times.

In an embodiment, the mixing assembly includes an automatic shut off feature, which turns off the motor automatically after it has been on a pre-determined or user selected length of time.

Various embodiments are described in this specification, with reference to the details discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one of ordinary skill in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those of ordinary skill in the art, and such modifications are also intended to fall within the scope of the claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All references including patents, patent applications, and publications cited herein are incorporated by reference in their entirety and for all purposes to the same extent as if each individual patent. patent application, or publication was specifically and individually indicated to be incorporated by reference in its entirety for all purposes.

What is claimed is:

1. A mixing assembly comprising:
a housing configured to interface with a hole in a lid of a container;
a motor disposed within the housing;
a power source configured to provide power to the motor;
a mixing element directly or indirectly attached to the motor, wherein the mixing element is sized to fit through the hole in the lid; and
at least one electrical connector pin electrically coupled to the motor;
at least one electrical connector pin electrically coupled to the power source;
wherein the electrical connector pins are configured so that a conductive element outside the housing can complete a circuit between the motor and the power source by electrically connecting the electrical pins to each other.

2. The mixing assembly of claim 1, wherein the housing is configured in a primarily cylindrical shape.

3. The mixing assembly of claim 2, wherein the electrical connector pins are disposed uniformly around a circular section of the housing.

4. The mixing assembly of claim 1, wherein the electrical connector pins are spring-loaded.

5. The mixing assembly of claim 1, wherein the conductive element is non-linear.

6. The mixing assembly of claim 1, wherein the housing comprises a top, and the top of the housing is substantially flat.

7. The mixing assembly of claim 6, wherein the top of the housing comprises a connector.

8. The mixing assembly of claim 1, wherein the housing comprises at least a first end, wherein the first end is configured to interface with the hole in the lid, wherein the first end comprises a portion that interfaces with a side of the hole in the lid.

9. The mixing assembly of claim 1, further comprising a switch for controlling the motor, wherein the motor is activated when both the switch and the second switch are actuated.

10. The mixing assembly of claim 1, wherein the housing comprises at least a first end, wherein the first end is configured to interface with the hole in the lid, wherein the power source is disposed within the housing proximate the first end.

11. A mixer kit, comprising:
a mixing assembly as recited in claim 1;
a lid for a container, the lid comprising a hole sized to accommodate insertion of the mixing assembly therein, the hole including an inside surface, the lid comprising a conductive element disposed on the inside surface of the hole, wherein the conductive element is configured to electrically connect the electrical connector pins when the mixing assembly is inserted into the hole.

12. The mixer kit of claim 11, wherein the conductive element is non-linear.

13. The mixer kit of claim 11, wherein the conductive element is a metal ring.

14. The mixer kit of claim 11, wherein the lid is child resistant.

15. The mixer kit of claim 14, wherein the lid is configured to require a squeeze and turn or push and turn motion to remove the lid from the container.

16. The mixer kit of claim 11, wherein the hole in the lid is sized to accommodate the passage of drink powders, pudding mixes, whipped topping, and sprinkles.

17. The mixer kit of claim 11, further comprising a straw adapter.

18. The mixer kit of claim 11, further comprising a storage disc.
